(19) United States
(12) Patent Application Publication
(10) Pub. No.: US 2010/0138278 A1
(43) Pub. Date: Jun. 3, 2010

(54) APPLICATIONS FOR TELECOMMUNICATIONS SERVICES USER PROFILING

(76) Inventors: Armen Aghasaryan, Nozay (FR); Marie-Pascale Dupont, Nozay (FR); Stéphane Betge-Brezetz, Nozay (FR)

Correspondence Address: FAY SHARPE/LUCENT, 1228 Euclid Avenue, 5th Floor, The Halle Building, Cleveland, OH, 44115-1843, US

(21) Appl. No.: 12/447,593

(22) PCT Filed: Oct. 29, 2007
(86) PCT No.: PCT/EP07/61625

§ 371 Date: Feb. 3, 2010

(30) Foreign Application Priority Data
Nov. 3, 2006 (FR) 0654703

(51) Int. Cl. G06Q 10/00; G06Q 50/00

(52) U.S. Cl. 705/10

(57) ABSTRACT

Computer program product comprising instructions to carry out profiling of a telecommunications services user in a multi-platform environment (1), such product being characterised in that it comprises:
a functional explicit profiling block (7) that gathers information on the user's preferences, directly from the said user;
a functional implicit profiling block (8) for the user, gathering raw data concerning the user's behaviour for each service delivery platform, such functional implicit profiling block (8) comprising aggregation means for such raw data;
   the profile thus shaped comprising core attributes independent from the service platform and specialised attributes depending on the platforms that are present in the environment.

The invention relates to the field of telecommunications services user profiling.

User profiling enables customisation of the information to be delivered to such users: advertising, location data, product and services catalogues, for example.

Internet user profiling has given rise to numerous technical developments. More than a billion pages can potentially be seen on the Web, and customisation of information is one of the solutions that can help keep the Internet a viable information resource. Information customisation is of particular importance for electronic commerce. Indeed, the extremely fast development of the Internet results in a profusion of information for each type of product or service, with the option of buying or entering into contracts online, so that the consumer is faced with a “hyperchoice” and tends to be less loyal, more unpredictable. Changing Internet sites at a click of a mouse is as common and fast as channel hopping on a satellite package or riffling through a paper encyclopaedia. One-to-one marketing is a response to the profusion of information to be found on the Web. The supplier offers services, information and customised products to an identified Internet user that will, in principle, truly be of interest for that particular user.

Telephony services user profiling has also given rise to technical developments. It is much more expensive to acquire a customer than to keep him or her. As an indication, the cost of acquiring a mobile telephony customer was in the order of ε300 in 2001. In France, each year more than one million mobile telephony users change their operator. Leaving for the competition (churn) is a major concern for all operators, and customised marketing is considered to be one of the methods to help reduce churn.

A convergence of the Internet, media and telecommunications sectors is currently taking place by means of the supply of Web connected multimedia services accessible in mobile mode. In addition to Voice Over IP, unified multimedia messaging, video telephony, interactive broadcasting, third generation (3G) mobile multimedia services must enable development of mobile commerce, in particular by the broadcast of information linked to the location of the mobile terminal. In this context, “mobile commerce” designates the option to carry out, by means of a mobile communication terminal, financial transactions for the purchase of products and services, or stock exchange transactions.

3G services user profiling is therefore just as important. This is of course the case for mobile commerce just as has already more generally been stated in connection with electronic commerce. It is also the case of the “location” service for the delivery of information taking into account both the location of the mobile terminal and the user's interests. Document FR-2810183 illustrates an idea of this kind: a server sends a vectorised map representation of the user's location, displaying the places that could be of interest to the user, where such types of places are known to the server to a PDA.

Services user profiling usually comprises the following steps:
gathering data concerning the user;
building the user's profile;
modelling of the user.

Data collection is, conventionally, an extraction of data from a user database having been loaded by means of various technical devices. For an Internet user, for example, the TCP/IP protocol implies the provision of an IP address, also enabling the server to know the following data: brand and version of the browser software, date and time of the connection, page on which an invisible hyperlink is activated. A great number of tools enable automatic collection of data specific to the Internet user, such as cookies, PSN (Processor Serial Number), GUID (Global Unique Identifier), BHO (Browser Helper Objects), GIF images (web bug) or html tags hidden as micro images inside a Web page. Among these tools, cookies are the most frequently employed in one-to-one marketing. They also make it possible to customise advertising. Cookies are physically managed by the browsers on behalf of the requesting Internet sites. Each cookie can store up to 4096 characters, and the browsers authorise the creation of approximately 20 cookies per site. Cookies help render browsing more comfortable (integration of preferences, e.g. language), answers to questions already asked, automatic display of the user's name, geographic location, appropriate advertising.

Service user modelling takes into account the user's personal information (e.g. age, language), preferences and focal points of interest, and the history of the use of the services by that user. In the standard approach, a current user is catalogued as compared to a typical predefined user. In another approach, the user's model is obtained by inference from information implicitly collected at the time when he or she used the services. In a first implementation, the user's behaviour can be assimilated to that of a group of users. In a second implementation, statistical tools are used: Linear tools, Markovian processes, neural networks, classification, rules induction, Bayesian networks.

The construction of the service user profile can be explicit, implicit or supervised. In an explicit construction, the information is supplied directly by the user. This information can be entered by the user or else be automatically acquired by the system. Implicit user profile construction is based on a context and user preferences inference procedure via his/her behaviour when using the services. This implicit construction conventionally implements Bayesian classification, neural networks and genetic algorithms. Supervised construction asks the consumer about his/her degree of satisfaction for each response generated by the service provider.

Telecommunications services consumers are faced with a multitude of composite service offers: combined voice-Internet-TV offer over high speed access (triple play), 3G portal services, television on mobile terminals.

This results in growing complexity in the use of the services, which is even more accentuated by the diversity of terminals on the market and of the networks capable of supporting such services.

For example, a video can be read in transit (streamed) from an Internet server to a PC terminal, or else cable broadcast to a TV screen, or else multibroadcast within a 3G network of mobile communication terminals.

As a result, profiling has become a critical feature for services providers and operators, as better understanding of consumer behaviour is expected to enable an increase in the value of service infrastructures (3G portals, for example), by supplying more targeted and customised services.

The profiling techniques currently proposed concern specific areas of application: Internet, telephony, for specific objectives.

For the Internet, Google has recently offered a product called Google Analytics, intended for website owners and enabling them to find out how their visitors interact with the site(s) and to identify traffic bottlenecks as well as to determine the most effective keywords in search engines.

Still on the Internet, document FR-2875040 describes a method and a device for analysing navigation on a site. Markers are incorporated into the pages of the website, and preferably on all pages. By “marker”, document FR 2785040 means a programme whose function it is to send to the site data concerning the page, the visitor, the communication session between the visitor and the site and the interactions having taken place between the visitor and the site. This program is for example in HTML (Hyper Text Markup Language). The marker implements for example the cookies technique. An event of interest is selected—for example, access to the General Conditions of Sale. A server self-learns the differences between the behaviour of “common” visitors who have not set off the event, and that of “special” visitors who did set off the event when visiting the site. The server implements a neural network. When a visitor's behaviour, during his/her visit, resembles the behaviour of a special visitor in a manner such that the current visit will probably lead to the event of interest, a communication element is incorporated into the page transmitted to the current visitor (for example a flash banner, pop-up window). The server self-learns the incidence of the communication element on the occurrence of the event of interest. The communication elements having most aided the arrival of the event of interest are thus selected.

For telecommunications services platforms, Siemens offers a product called Service Delivery Manager tSM (tango SM) for broadband services. Nokia Technology Platform developed software for the Nokia 60 Series smartphones, enabling collation of use data (40 to 80 kB/month/user). Based on a voluntary user panel, data mining made it possible to isolate user and use profiles (cf. Hannu Verkasalo, Handset-Based Monitoring of Mobile Customer Behavior). Document GB2366699 describes profiling means for the behaviour of mobile telephone users for fraud detection purposes.

It has been proposed for the implementation of the profiling to take into account the characteristics of the user's communication terminal.

Thus, for example, Applicant's document FR2792484 describes a customised communication network. A server contains information concerning the users (personalities, habits) and their terminals (characteristics of the graphic interface, of the audio interface, processor operating frequency). User data are pre-loaded or supplied online. A user interface is built based on the users' queries, and contains only objects or applications adapted to the user's terminal. Document EP 1 211 618 describes a method and a device to furnish advertising to a multimedia terminal, independently of the type of terminal. The device comprises portable means of the chip card type, connected to the communication terminal, where such means include a processor and a memory. The user's profile is stored in the memory. The processor recognises the type of terminal and then selects, from the memory, the advertising that is appropriate for the identified type of terminal and to the user's profile.

Previous telecommunications services user profiling techniques are dedicated only to one type of application (Internet, telephony) and, most often, to a given type of terminal (computer, mobile phone, smartphone). Transposition of a technique designed and configured for a given application to another application would be long, complex and tedious.

The invention aims to remedy this difficulty by proposing a telecommunications services user profiling technique adapted to the context of provision of multiple services.

Advantageously, the profiling technique according to the invention must enable aggregation of all information available on the behaviour of telecommunications services consumers as well as on their equipment.

For this purpose, the invention refers, in a first aspect, to a computer program product comprising instructions to carry out profiling of a telecommunications services user in a multi-platform environment, such product comprising:
a functional explicit profiling block that gathers information on the user's preferences, directly from the said user;
a functional implicit profiling block for the user, gathering raw data concerning the user's behaviour for each service delivery platform, such functional implicit profiling block comprising aggregation means for such raw data;
   the profile thus shaped comprising core attributes independent from the service platform and specialised attributes depending on the platforms that are present in the environment.

Advantageously, the product further comprises a functional configuration block gathering the user's behavioural features for a platform introduced in the environment, such features being broken down among those already included in the user's profile and those that are new, with a functional extension block ensuring aggregation of such new features.

In an advantageous embodiment, the product comprises, among other things, a functional requests block, providing an access and query interface for applications whose operation depends on the user's profile.

Advantageously, a functional confidentiality block takes into account the legal constraints and/or the users' wishes as concerns the storage of personal data.

In a second aspect, the invention concerns a server comprising means to receive a request for a connection from a user terminal to at least one service delivery platform, such server comprising:
explicit user profiling means that gather information on the user's preferences, directly from the said user;
implicit user profiling means, gathering raw data concerning the user's behaviour for each service delivery platform, such implicit profiling means comprising aggregation means for such raw data;
means for storage of the user profile thus shaped, such profile comprising core attributes independent from the service platform and specialised attributes depending on the platforms.

In a third aspect, the invention concerns a network comprising a server as presented above, and multiple platforms for delivery of services to mobile communication terminals.

Contrary to existing techniques, the profiling technique according to the invention is a multi-platform technique. The invention is thus adapted to major operators offering both communications and multimedia services on their fixed and mobile networks. The personalised services offered can be improved, and new applications based on knowledge of the user profiles are permitted.

Other objects and advantages of the invention will become apparent upon reading the description below, with reference to the attached drawings, in which:

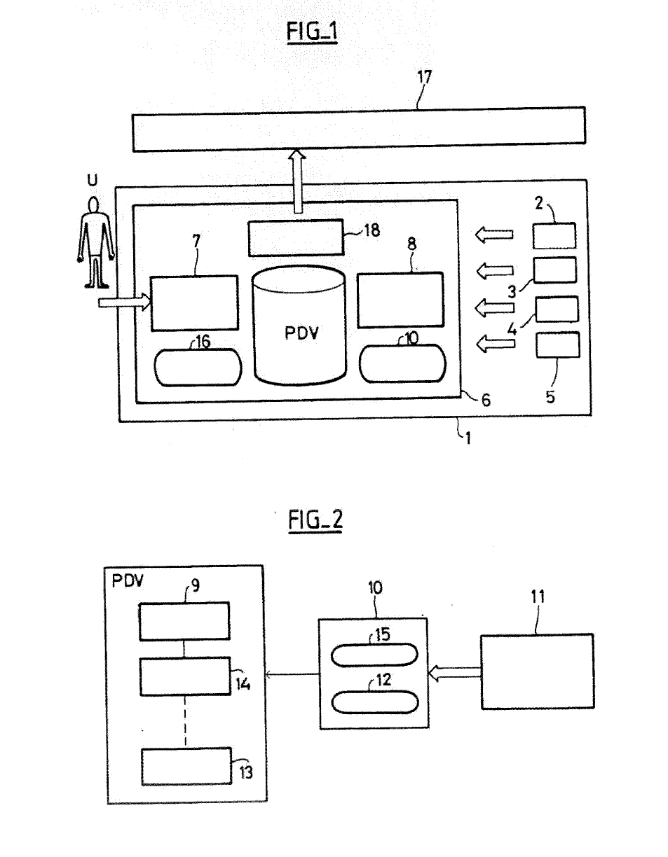

FIG. 1 is a schematic view of a multiplatform operator environment implementing the invention, in one embodiment.

FIG. 2 is a schematic view of a configuration of a multiplatform profile generator according to the invention.

FIG. 1 schematically shows an environment 1 for the delivery of telecommunications services. In this multi-platform environment several service delivery platforms are accessible to the user U. Four platforms are schematically shown in FIG. 1, and it is understood that this number is given by way of example and not of limitation. For example, a first platform 2 delivers videos to mobile terminals, a second platform 3 delivers at least one television programme to mobile terminals, a third platform 4 delivers at least one television programme via the Internet (Internet Protocol Television), a fourth platform 5 delivers communication services over IP (e-learning, IMS IP Multimedia Subsystem).

A programme module automatically aggregates the service use data from the different platforms 2-5. Hereafter, the said programme module 6 will be denominated Profile Enabler, the term Enabler conventionally designating a technological solution supporting a single functionality.

The Profile Enabler 6 includes several blocks, for specific functions.

The explicit profiling block 7 gathers information on the preferences of the users U directly from such users, e.g. via a user friendly interface. The said interface is, in particular, accessible via the Internet.

The implicit user profiling block 8 is in charge of collecting basic data concerning the user for each service delivery platform 2-5. This implicit profiling block 8 implements the aggregation and/or the inference for updating attributes in the user profile.

The basic data concerning the users U are e.g. the recording of the services session logs.

Some examples of raw data are given below, received from a Video on Demand VoD server:

Session [03-02-06, 18:50, User Id 10023]: Video [#5507, Sport, 10mn],
Music [#6758, Rock, 4mn]
Session [03-02-06, 18:55, User Id 6765]: Video [#8763, News headlines,
5mn]

A data structure describing the user profile is thus defined. It can include traditional user information such as age, sex, mother tongue, as well as data concerning services consumption statistics (video, mail). Another set of data is shaped by the semantic data (centres of interest, consumer category). Some examples of consumption data and centres of interest are shown below:

Video: #streamed videos/day/WE, #downloaded videos/day/WE,
average session duration . . .
Portal: #downloaded ringtones/day/WE, #browsed pages/Day/WE,
Top10 WAP/WEB pages . . .
Messaging: #SMS/MMS messages out/Day/WE, #SMS/MMS
messages in/day/WE . . .
Interest domains: Sports, News, Entertainment, etc.

The list of all characteristics describing the profile of the user and of his/her behaviour is designated by the profile data vector or PDV.

Some of the attributes of the user profile are defined as core features 9 while other attributes are further specialised to be used as a function of the service provision platforms present in a given environment.

The modification of the environment 1 by addition or removal of a platform is managed as follows in the profile enabler 6.

The functional configuration block 10 (enabler configuration) supports the introduction of new platforms 11 for the delivery of services within the environment.

In fact, the use of a new service delivery platform results in the creation of new characteristics that were not present in the profile data vector. This is the role of the functional extension block 12. The aggregation/inference logic is defined for such new characteristics 13. At the same time, a new service delivery platform 11 may require user profile characteristics 14 that are already present in the profile data vector. In that case, the aggregation/inference logic is adapted to take into account the new sources of information for their aggregation 15 to the existing profile.

The confidentiality block 16 takes into account the legal constraints concerning the storage and analysis of users' personal data.

Furthermore, the Profile Enabler 6 must offer extraction capabilities that can be used with various applications 17: targeted advertising, personalised information, network applications based on the users' profiles to access the aggregated data.

The functional request bloc 18 (Profile Data Query) provides an access and query interface for the applications 17 that use user profile data (e.g. an API application programme interface for SQL databases).

The profile Enabler may be used by two main application categories:

personalisation and customisation applications, which use profiling information to deliver a more dedicated and targeted service to the profiled users: targeted advertising, graphical user interfaces depending on the type of user (experienced or basic users), recommendation systems (in Internet browsing, recommendation of mobile commerce products and services);

applications using profile data in a manner inherent to their logical service: personalised content applications, or social network applications.

Platforms offering services intended for mobile terminals must take into account the reduced size of the screens of such devices, the customisation of the display of such information and the personalisation of the information itself, enabling a limitation of the time and effort dedicated to the search for such information.

1. A method for profiling a telecommunications services user in a multi-platform environment (1), characterised in that it comprises:
provision to the user of access to several service delivery platforms,
provision to the user of access to a user interface,
performance of explicit user profiling comprising information on the user's preferences gathered directly from the latter via the said interface;
performance of implicit user profiling comprising raw data relative to the user's behaviour when using services originating from the said platforms, such raw data being aggregated;
based on explicit and implicit profiling thus carried out, constitution of a user profile comprising:
core attributes (9) independent from the service platform, and
specialised attributes depending on the platforms that are present in the environment.

2. Profiling method according to claim 1, characterised in that it comprises a configuration operation consisting in collecting the user's behavioural characteristics for a platform (11) introduced in the environment (1), such characteristics being broken down into those already included in the user profile and new ones, and in aggregating such new characteristics by means of a functional extension block (12).

3. Profiling method according to claim 2, characterised in that it comprises, among other things, the provision of an access and query interface for applications (17) whose operation depends on the user's profile.

4. Profiling method according to claim 2, characterised in that it comprises, among other things, consideration of the legal constraints and/or the users' wishes as concerns the storage of personal data.

5. Server comprising means to receive a request for a connection from a user terminal to at least one service delivery platform, such server being characterised in that it comprises:
explicit user profiling means that gather information on the user's preferences, directly from the said user;
implicit user profiling means, gathering raw data concerning the user's behaviour for each service delivery platform, such implicit profiling means comprising aggregation means for such raw data;
means for storage of the user profile thus shaped, such profile comprising core attributes independent from the service platform and specialised attributes depending on the platforms.

6. A server according to claim 5, implemented in a network having multiple platforms for delivery of services to mobile communication terminals.
